(19) United States
(12) Patent Application Publication
(10) Pub. No.: US 2022/0382546 A1
(43) Pub. Date: Dec. 1, 2022

(54) APPARATUS AND METHOD FOR IMPLEMENTING VECTOR MASK IN VECTOR PROCESSING UNIT

(71) Applicant: ANDES TECHNOLOGY CORPORATION, Hsinchu City (TW)

(72) Inventors: Thang Minh Tran, Tustin, CA (US); Chia-Wei Hsu, Tainan City (TW)

(73) Assignee: ANDES TECHNOLOGY CORPORATION, Hsinchu City (TW)

(21) Appl. No.: 17/334,805

(22) Filed: May 31, 2021

(51) Int. Cl. G06F 9/30

(52) U.S. Cl. CPC G06F 9/30018; G06F 9/30036

(57) ABSTRACT

The mask data corresponding to each data element of the issued instruction may be handled by a mask queue, where only the valid mask data are stored to the mask queue. The mask data of multiple vector instructions may be stored in the mask queue. The corresponding mask data may be accessed from the mask queue when the vector instruction(s) is dispatched from the execution queue to the functional unit for execution. In the case of 512-bit wide mask data is needed, the issuing of the vector instruction from the decode/issue unit to the execution queue may be stalled until the mask queue is available. In some embodiments, one mask queue may be dedicated to one execution queue. Alternatively, one mask queue may be shared between two different execution queues. In the disclosure, resources are conserved without dedicating additional storage space for handling mask data of the vector instruction.

### BACKGROUND

### Technical Field

The disclosure generally relates to a microprocessor, and ore specifically, to a method and a microprocessor for processing vector instructions.

### Description of Related Art

Single Instruction Multiple Data (SIMD) architectures achieve high performance by executing multiple data elements designated by SIMD instruction (also referred to as vector instruction) in parallel, whereas a scalar instruction processes only one data element or a pair of data elements (i.e., two source operands). Each of the data elements may represent an individual piece of data (e.g., pixel data, graphical coordinate, etc.) that is stored in the register or other storage location along with other data elements commonly having the same size. The number of data elements designated by the vector instruction greatly varies based on the data element size and vector length multiplier (LMUL). For example, when LMUL is 1, a 512-bit wide vector data may have sixty-four 8-bit wide elements, thirty-two 16-bit wide data elements, sixteen 32-bit wide data elements, and so on. When LMUL is 8, the 512-bit wide vector data may have five hundred and twelve 8-bit wide data elements, two hundred and fifty-six 16-bit wide data elements, one hundred and twenty-eight 32-bit wide data elements, and so on.

In processing of vector instruction, each data element of the vector register would be attached with a mask bit which masks the corresponding data element to the designated operation when enabled. In a worst-case scenario, all 512 bits of a mask vector register would be used for five hundred and twelve 8-bit wide data elements. On the other hand, only 16 bits of a 512-bit mask vector register are needed for a 512-bit wide vector data having sixteen 32-bit wide data elements. Although not all vector instruction is worst case scenario, each vector instruction is still issued with 512-bit mask data to cover the all possibilities of predication, regardless of whether all 512-bit mask data are required by the vector instruction or not (i.e., brute-force implementation of mask data). Such implementation of mask data with vector instruction takes up a lot of storage area and power for pluralities of queued vector instructions in the pluralities of execution pipelines of a vector processor.

### SUMMARY

The disclosure introduces a mask queue that manages the mask data of data elements corresponding to the vector instruction(s) that is issued from a decode/issue unit to an execution queue.

In the disclosure, the mask data corresponding to data elements of the issued instruction may be handled or managed by the introduced mask queue, where only the valid mask data for all vector instructions in an execution queue are stored to the mask queue. In the disclosure, mask data of multiple vector instructions may be stored in the mask queue. The corresponding mask data may be accessed from the mask queue when the vector instruction(s) is dispatched from the execution queue to the functional unit for execution. Issuing of the vector instruction from the decode/issue unit to the execution queue may be stalled if the mask queue does not have enough available entries. In some embodiments, one mask queue may be dedicated to one execution queue. In some other embodiments, one mask queue may be shared between two different execution queues. In the disclosure, resources are conserved without dedicating additional storage space for handling mask data of the vector instruction. That is, the mask queue would only read the mask data required by the vector instruction(s) from the mask register when the vector instruction(s) is issued to the execution queue. The implementation of the mask queue greatly reduces the resource required for managing the mask of data elements for processing vector instruction.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram illustrating a data processing system in accordance with some embodiments.

FIG. 2 is a diagram illustrating a scoreboard and a register file in accordance with some embodiments of the disclosure.

FIGS. 3A-3B are diagrams illustrating various structures of a scoreboard entry in accordance with some embodiments of the disclosure.

FIG. 4 is a diagram illustrating a vector execution queue in accordance with some embodiments of the disclosure.

FIG. 5 is a diagram illustrating the mask queue in accordance with some embodiments of the disclosure.

FIGS. 6A-6C are diagrams illustrating an operation of issuing a vector instruction to an execution queue and a mask queue in accordance with some embodiments of the disclosure.

### DESCRIPTION OF THE EMBODIMENTS

The following disclosure provides many different embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The disclosure introduces a mask queue that manages the mask data of data elements corresponding to the vector instruction(s) that is issued. In brute-force implementation of mask operation, each instruction is issued with entire mask register (e.g., 512 bits) to an execution queue, regardless of whether all of the mask data would be required or not. If the execution queue has 8 entries, the mask storage would be 4096 bits (i.e., 8×512). If there are 8 execution queues, the mask storage would be 32768 bits (i.e., 8×8×512). Since not all of the vector instruction(s) would use 512 bits of mask, the mask storage of the brute-force implementation is wasteful. In the disclosure, the mask queue would only read the mask data required by the vector instruction(s) from the mask register when the vector instruction(s) is issued to the execution queue. The implementation of the mask queue greatly reduces the resource required for managing the mask of data elements for processing vector instruction.

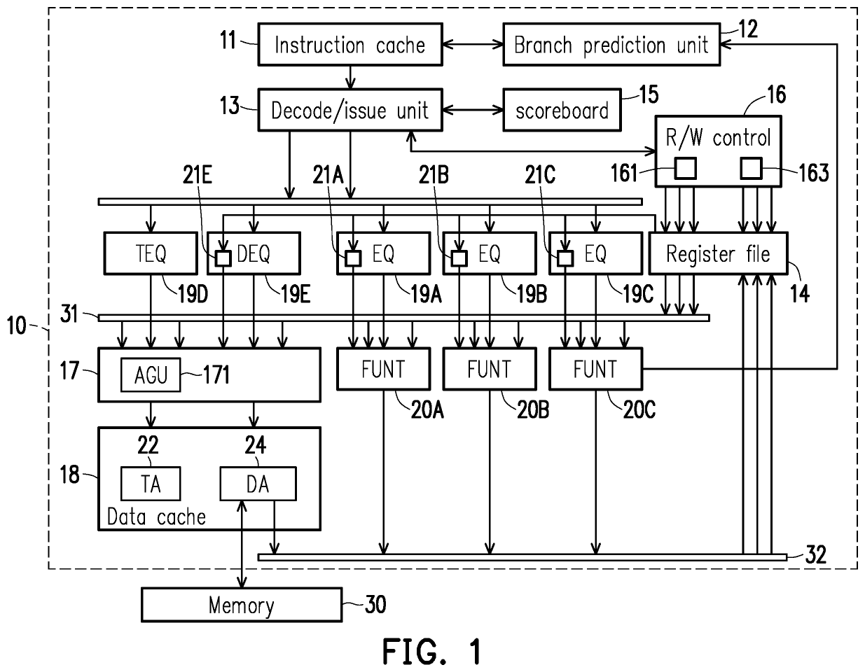

Referring to FIG. 1, a schematic diagram of a data processing system 1 including a microprocessor 10 and a memory 30 is illustrated in accordance with some embodiments. The microprocessor 10 is implemented to perform a variety of data processing functionalities by executing instructions stored in the memory 30. The memory 30 may include level 2 (L2) and level 3 (L3) caches and a main memory of the data processing system 1, in which the L2 and L3 caches has faster access times than the main memory. The memory may include at least one of random access memory (RAM), dynamic random access memory (DRAM), static random access memory (SRAM), read only memory (ROM), programmable read only memory (PROM), electrically programmable read only memory (EPROM), electrically erasable programmable read only memory (EEPROM), and flash memory.

The microprocessor 10 may be a general-purpose processor (e.g., a central processing unit) or a special-purpose processor (e.g., network processor, communication processor, DPSs, embedded processor, etc.) The processor may have any of the instruction set architectures such as Complex Reduced Instruction Set Computing (CISC), Reduced Instruction Set Computing (RISC), Very Long Instruction Word (VLIW), hybrids thereof, or other type of instruction set architectures. In some of the embodiments, the microprocessor is a RISC processor that performs predication or masking on vector instructions. The microprocessor implements an instruction-level parallelism within a single microprocessor and achieves high performance by executing multiple instructions per clock cycle. Multiple instructions are dispatched to different functional units for parallel execution. The superscalar microprocessor may employ out-of-order (OOO) execution, in which a second instruction without any dependency on a first instruction may be executed prior to the first instruction. In traditional out-of-order microprocessor design, the instructions can be executed out-of-order but they must retire to a register file of the microprocessor in-order because of control hazards such as branch misprediction, interrupt, and precise exception. Temporary storages such as re-order buffer and register renaming are used for the result data until the instruction is retired in-order from the execution pipeline. The microprocessor 10 may execute and retire instruction out-of-order by write back result data out-of-order to the register file as long as the instruction has no data dependency and no control hazard.

Referring to FIG. 1, the microprocessor 10 may include an instruction cache 11, a branch prediction unit (BPU) 12, a decode/issue unit 13, a register file 14, a scoreboard 15, a read/write control unit 16, a load/store unit 17, a data cache 18, a plurality of execution queues (EQs) 19A-19E, and a plurality of functional units (FUNTs) 20A-20C. The microprocessor 10 also includes a read bus 31 and a result bus 32. The read bus 31 is coupled to the load/store unit 17, the functional units 20A-20C, and the register file 14 for transmitting operand data from registers in the register file 14 to the load/store unit 17 and the functional units 20A-20C, which may also be referred to as an operation of reading operation data from the register file 14. The result bus 32 is coupled to the data cache 18, functional units 20A-20C, and the register file 14 for transmitting data from the data cache 18 or functional units 20A-20C to the registers of the register file 14, which may also be referred to as an operation of writeback result data to the register file 14. Elements referred to herein with a particular reference number followed by a letter will be collectively referred to by the reference number alone. For example, execution queues 19A-19E and functional units 20A-20C may be collectively referred to as execution queues 19 and functional unit 20, respectively, unless specified. Some embodiments of the disclosure may use more, less, or different components than those illustrated in FIG. 1.

In some embodiments, the instruction cache 11 is coupled (not shown) to the memory 30 and the decode/issue unit 13, and is configured to store instructions that are fetched from the memory 30 and dispatch the instructions to the decode/issue unit 13. The instruction cache 11 includes many cache lines of contiguous instruction bytes from memory 30. The cache lines are organized as direct mapping, fully associative mapping or set-associative mapping, and the likes. The direct mapping, the fully associative mapping and the set-associative mapping are well-known in the relevant art, thus the detailed description about the above mappings are omitted.

The instruction cache 11 may include a tag array (not shown) and a data array (not shown) for respectively storing a portion of the address and the data of frequently-used instructions that are used by the microprocessor 10. Each tag in the tag array is corresponding to a cache line in the data array. When the microprocessor 10 needs to execute an instruction, the microprocessor 10 first checks for an existence of the instruction in the instruction cache 11 by comparing address of the instruction to tags stored in the tag array. If the instruction address matches with one of the tags in the tag array (i.e., a cache hit), then the corresponding cache line is fetched from the data array. If the instruction address does not match with any entry in the tag array (i.e., a cache miss), the microprocessor 10 may access the memory 30 to find the instruction. In some embodiments, the microprocessor 10 further includes an instruction queue (not shown) that is coupled to the instruction cache 11 and the decode/issue unit 13 for storing the instructions from the instruction cache 11 or memory 30 before sending the instructions to the decode/issue unit 13.

The BPU 12 is coupled to the instruction cache 11 and is configured to speculatively fetch instructions subsequent to branch instructions. The BPU 12 may provide prediction to branch direction (taken or not taken) of branch instructions based on the past behaviors of the branch instructions and provide the predicted branch target addresses of the taken branch instruction. The branch direction may be “taken”, in which subsequent instructions are fetched from the branch target addresses of the taken branch instruction. The branch direction may be “not taken”, in which subsequent instructions are fetched from memory locations consecutive to the branch instruction. In some embodiments, the BPU 12 implements a basic block branch prediction for predicting the end of a basic block from starting address of the basic block. The starting address of the basic block (e.g., address of the first instruction of the basic block) may be the target address of a previously taken branch instruction. The ending address of the basic block is the instruction address after the last instruction of the basic block which may be the starting address of another basic block. The basic block may include a number of instructions, and the basic block ends when a branch in the basic block is taken to jump to another basic block.

The decode/issue unit 13 may decode the instructions received from the instruction cache 11. The instruction may include the following fields: an operation code (or opcode), operands (e.g., source operands and destination operands), and an immediate data. The opcode may specify which operation (e.g., ADD, SUBTRACT, SHIFT, STORE, LOAD, etc) to carry out.

The operand may specify the index or address of a register in the register file 14, where the source operand indicates a register from the register file from which the operation would read, and the destination operand indicate a register in the register file to which a result data of the operation would write back. It should be noted that the source operand and destination operand may also be referred to as source register and destination register, which may be used interchangeably hereinafter. In the embodiment, the operand would need 5-bit index to identify a register in a register file that has 32 registers. Some instructions may use the immediate data as specified in the instruction instead of the register data. Each instruction would be executed in a functional unit 20 or the load/store unit 17. Based on the type of operation specified by the opcode and availability of the resources (e.g., register, functional unit, etc.), each instruction would have an execution latency time and a throughput time. The execution latency time (or latency time) refers to the amount of time (i.e., the number of clock cycles) for the execution of the operation specified by the instruction(s) to complete and writeback the result data. The throughput time refers to the amount of time (i.e., the number of clock cycles) when the next instruction can enter the functional unit 20.

In the embodiments, instructions are decoded in the decode/issue unit 13 to obtain the execution latency time, the throughput time, and instruction type based on the opcode. Multiple instructions may be issued to one execution queue 19, where the throughput time of multiple instructions are accumulated. The accumulated throughput time indicates when the next instruction to be issued can enter the functional unit 20 for execution (i.e., the amount of time an instruction must wait before entering the functional unit 20) in view of the previously issued instruction(s) in the execution queue 19. The time defining when an instruction to be issued can be sent to the functional unit 20 is referred to as read time (from the register file) and the time defining when the instruction is completed by the functional unit 20 is referred to referred to as write time (to the register file). The instructions are issued to the execution queues 19 where each issued instruction has a scheduled read time to dispatch to the corresponding functional unit 20 or load/store unit 17 for execution. At the issue of an instruction, the accumulated throughput time of the issued instruction(s) in the execution queue 19 is the read time of the instruction to be issued. The execution latency time of the instruction to be issued is added to the accumulated throughput time to generate the write time when the instruction is issued to the next available entry of the execution queue 19. The modified execution latency time would be referred to herein as a write time of the most recent issued instruction, and the modified start time would be referred to herein as a read time of a next instruction to be issued. The write time and read time may also be collectively referred to as an access time which describes a particular time point for the issued instruction to write to or read from a register of the register file 14. Since the source register(s) is scheduled to read from the register file 14 just in time for execution by the functional unit 20, no temporary register is needed in the execution queue for source register(s) which is an advantage in comparison to other microprocessor in one of the embodiments. Since the destination register is scheduled to write back to the register file 14 from the functional unit 20 or data cache 24 at the exact time in the future, no temporary register is needed to store the result data if there are conflicts with other functional units 20 or data cache 24 in one of the embodiments, which is an advantage in comparison to other microprocessor. For parallel issuing of more than one instruction, the write time and the read time of a second instruction may be further adjusted based on a first instruction which was issued prior to the second instruction.

For vector processing, the decode/issue unit 13 reads mask data from mask vector register v(0) of the register file 14 and attached the mask data with the vector instruction to the execution queue 19. Each execution queue 19 includes a mask queue 21 to keep the mask data for each issued vector instruction in the execution queue 19. When the instruction is dispatched from the execution queue 19 to the functional unit 20, the mask data is read (if the mask operation is enabled) from the mask queue 21 and sent with the instruction to the functional unit 20.

In the embodiments, the decode/issue unit 13 is configured to check and resolve all possible conflicts before issuing the instruction. An instruction may have the following 4 basic types of conflicts: (1) data dependency which includes write-after-read (WAR), read-after-write (RAW), and write-after-write (WAW) dependencies, (2) availability of read port to read data from the register file to the functional unit, (3) availability of the write port to write back data from the functional unit to the register file, and (4) the availability of the functional unit 160 to execute data. The decode/issue unit 13 may access the scoreboard 15 to check data dependency before the instruction can be issued to the execution queue 19. Furthermore, the register file 14 has limited number of read and write ports, and the issued instructions must arbitrate or reserve the read and write ports to access the register file 14 in future times. The decode/issue unit 13 may access the read/write control unit 16 to check the availability of the read ports and write ports of the register file 14, as to schedule the access time (i.e., read and write times) of the instruction. In other embodiments, one of the write ports may be dedicated for instruction with unknown write time to write back to the register file 14 without using the write port control, and one of the read ports may be reserved for instructions with unknown read time to read data from the register file 14 without using the read port control. The read ports of the register file 14 can be dynamically reserved (not dedicated) for the read operations having unknown access time. In this case, the functional unit 20 must ensure that the read port is not busy when trying to read data from the register file 14. In the embodiments, the availability of the functional unit 20 may be resolved by coordinating with the execution queue 19 where the throughput times of queued instructions (i.e., previously issued to the execution queue) are accumulated. Based on the accumulated throughput time in the execution queue, the instruction may be dispatched to the execution queue 19, where the instruction may be scheduled to be issued to the functional unit 20 at a specific time in the future at which the functional unit 20 is available.

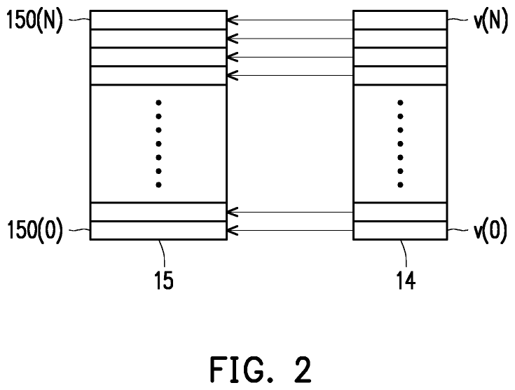

FIG. 2 is a block diagram illustrating a register 14 and a scoreboard 15 in accordance with some embodiments of the disclosure. The register file 14 may include a plurality of vector registers v(0)-v(N), read ports and write ports (not shown), where N is an integer greater than 1. In the embodiments, the register file 14 may include scalar register(s) and/or vector register(s). The disclosure is not intended to limit the number of registers, read ports and write ports in the register file 14. In the embodiments, one of the vector registers included in the register filed 14 would be used to present the mask data of vector processing, and thus the appearance of the term register hereinafter refers to vector processor unless specified otherwise. The scoreboard 15 includes a plurality of entries 150(0)-150(N), and each scoreboard entry corresponds to one register in the register file 14 and records information related to the corresponding register. In the embodiment, the scoreboard 15 has the same number of entries as the register file 14 (i.e., N number of entries), but the disclosure is not intended to limit the number of the entries in the scoreboard 15.

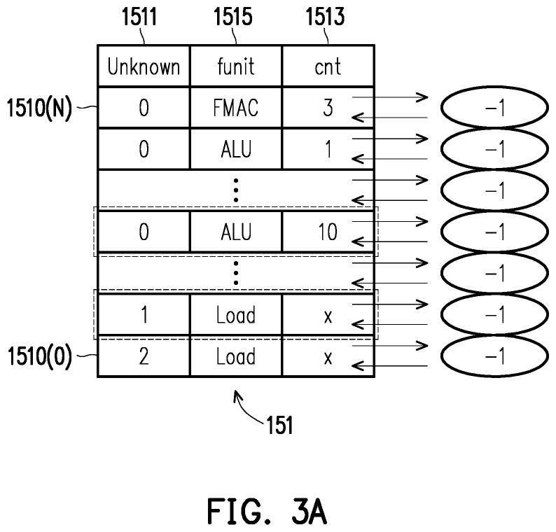

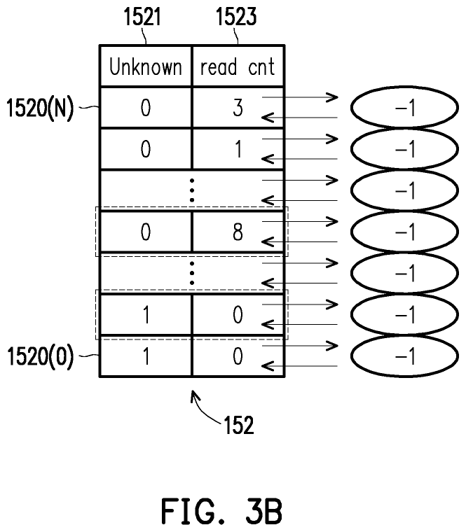

FIGS. 3A-3B are diagrams illustrating various structures of scoreboard entry in accordance with some embodiments of the disclosure. In the embodiments, the scoreboard 15 may include a first scoreboard 151 for handling writeback operation to the register file 14 and a second scoreboard 152 for handling read operation from the register file 14. The first and second scoreboards 151, 153 may or may not coexist in the microprocessor 10. The disclosure is not intended to limited thereto. In other embodiments, the first and second scoreboard 151, 153 may be implemented or view as one scoreboard 15 that handles both read and write operations. FIG. 3A illustrates the first scoreboard 151 for destination register of the issued instruction. FIG. 3B illustrates a scoreboard 152 for source registers of the issued instruction. With reference to FIG. 3A, each entry 1510(0)-1510(N) of the first scoreboard 151 includes an unknown field (“Unknown”) 1511, a write count field (“CNT”) 1513 and a functional unit field (“FUNIT”) 1515. Each of these fields records information related to the corresponding destination register that is to be written by issued instruction(s). These fields of the scoreboard entry may be set at a time of issuing an instruction.

The unknown field 1511 includes a bit value that indicates whether the write time of a register corresponding to the scoreboard entry is known or unknown. For example, the unknown field 1511 may include one bit or any number of bits, where a non-zero value indicates that the register has unknown write time, and a zero value indicates that the register has known write time as indicated by the write count field 1513. The unknown field 1511 may be set or modified at the issue time of an instruction and reset after the unknown register write time is resolved. For example, the reset operation may be performed by either the decode/issue unit 13, a load/store unit 17 (e.g., after a data hit), or a functional unit 20 (e.g., after INT DIV operation resolve the number of digits to divide), and other units in the microprocessor that involves execution of instruction with unknown write time. The write count field 1513 records a write count value that indicates the number of clock cycles before the register can be accessed by the next instruction (that is to be issued). In other words, the write count field 1513 records the number of clock cycles for which the previously issued instruction(s) would complete the operation and writeback the result data to the register. The write count value of the write count field 1513 is set based on the write time (may also be referred to as execution latency time) of an instruction at the issue time of the instruction. Then, the write count value counts down (i.e., decrement by one) for every clock cycle until the count value become zero (i.e., a self-reset counter). The functional unit field 1515 of the scoreboard entry specifies a functional unit 20 (designated by the issued instruction) that is to write back to the register.

With reference to FIG. 3B, the second scoreboard 152 having the structure of scoreboard entry 1520(0)-1520(N) is designed to resolve a conflict in writing to a register corresponding to a scoreboard entry before an issued instruction read from the register (i.e., WAR data dependency). This scoreboard may also be referred to as a WAR scoreboard for resolving WAR data dependency. Each of the scoreboard entry 1520(0)-1520(N) includes an unknown field 1521 and a read count field 1523. The functional unit field may be omitted in the implementation of the WAR scoreboard. The unknown field 1521 includes a bit value that indicates whether the read time of a register corresponding to the scoreboard entry is known or unknown. For example, the unknown field 1521 may include one bit, where a non-zero value indicates that the register has unknown read time, and a zero value indicates that the register has known read time as indicated by the read count field 1523. Similar to the unknown field 1511 illustrated in FIG. 3A, the unknown field 1521 may include any number of bits to indicate that one or more issued instruction(s) with unknown read time is scheduled to read from the register. The operation and the functionality of the unknown field 1521 is similar to the unknown field 1511, and therefore, details of which is omitted for the purpose of brevity. The read count field 1523 records a read count value that indicates the number of clock cycles for which the previously issued instruction(s) would take to read from the corresponding register. The read count value counts down by one for every clock cycle until the read count value reaches 0. The operation and functionality of the read count field 1523 is similar to the write count field 1513 unless specified, and thus the detail of which is omitted.

With reference to FIG. 1, the read/write control unit 16 is configured to record the availability of the read ports and/or the write ports of the register file 14 at a plurality of clock cycles in the future for scheduling the access of instruction(s) that is to be issued. At time of issuing an instruction, the decode/issue unit 13 access the read/write control unit 16 to check availability of the read ports and/or the write ports of the register file 14 based on the access time specified by the instruction. In detail, the read/write control unit 16 selects available read port(s) in a future time as a scheduled read time to read source operands to the functional units 20, and selects available write port(s) in a future time as a scheduled write time to write back result data from the functional units 20. In the embodiments, the read/write control unit 16 may include a read shifter (not shown) and a write shifter (not shown) for scheduling the read port and the write port. Each of the read shifter and write shifter includes a plurality of shifter entries, where each entry corresponds to a clock cycle in the future and records an address of register to be access and a functional unit that is to access the register at the corresponding clock cycle. In the embodiments, one entry would be shifted out for every clock cycle. In some embodiments, each read port and each write port of the register file 14 may correspond to a read shifter and write shifter.

The vector execution queues 19 are configured to hold issued vector instructions which are scheduled to be dispatched to the functional units 20. In the embodiments, each vector execution queue 19 includes a mask queue 21 that stores mask data corresponding to the vector instructions issued to the execution queue 19. With reference to FIG. 1, the vector execution queue 19A includes a mask queue 21A, the vector execution queue 19B includes a mask queue 21B, the vector execution queue 19C includes a mask queue 21C, and so on. The functional unit 20 may include, but not limited to, integer multiply, integer divide, an arithmetic logic unit (ALU), a floating-point unit (FPU), a branch execution unit (BEU), a unit that receive decoded instructions and perform operations, or the like. In the embodiments, each of the execution queues 19 are coupled to or dedicated to one of the functional units 20. For example, the execution queue 19A is coupled between the decode/issue unit 13 and the corresponding functional unit 20A to queue and dispatch the instruction(s) that specifies an operation for which the corresponding functional unit 20A is designed. Similarly, the execution queue 19B is coupled between the decode/issue unit 13 and the corresponding functional unit 20B, and the execution queue 19C is coupled between the decode/issue unit 13 and the corresponding functional unit 20C. In the embodiments, the execution queues 19D, 19E are coupled between the decode/issue unit 13 and the load/issue unit 17 to handle the load/store instructions.

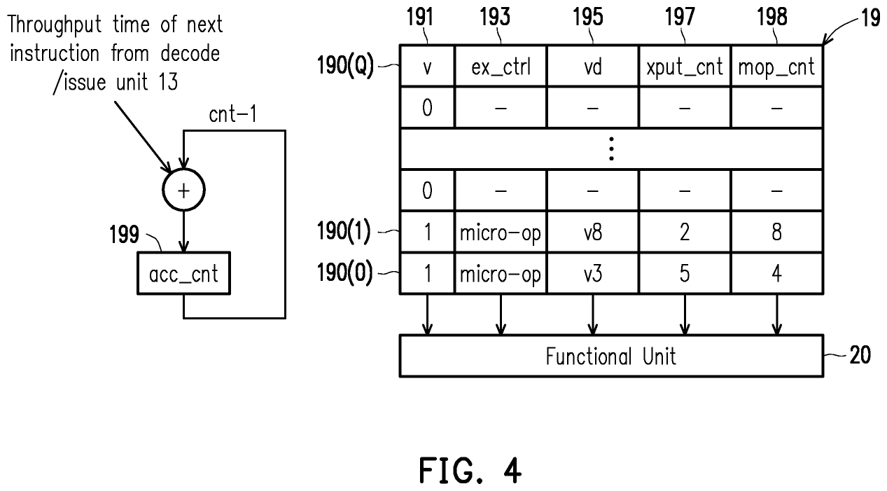

FIG. 4 is a diagram illustrating a vector execution queue 19 in accordance with some embodiments of the disclosure. The vector execution queue 19 may include a plurality of execution queue entries 190(0)-190(Q) for recording information about vector instructions issued from the decode/issue unit 13, where Q is an integer greater than 1. In the embodiments, each entry of the execution queue 19 includes, but not limited to, a valid field (“v”) 191, an execution control data field (“ex_ctrl”) 193, an address field (“vd”) 195, a throughput count field (“xput_cnt”) 197, and a micro-op count field (“mop_cnt”) 198. The embodiments are not intended to limit the information or number of fields to be included in each entry of vector execution queue 19. In alternative embodiments, more or fewer fields may be used to record fewer or more information in each execution queue. It should also be noted that each of the functional units 20A-20C may be couple to a vector execution queue that is the same or similar to the vector execution queue illustrated in FIG. 4, where each of the vector execution queues 19A-19C receives vector instructions issued from the decode/issue unit 13 and dispatches the received vector instructions to the corresponding functional unit 20A-20C.

The valid field 191 indicates whether an entry is valid or not (e.g., valid entry is indicated by “1” and invalid entry is indicated by “0”). The execution control data field 193 indicates an execution control information for the corresponding functional unit 20 which is derived from the received vector instruction. The address field 195 records the address of register to which the vector instruction accesses. The throughput count field 197 records a throughput count value that represents the number of clock cycles for the functional unit 20 to accept the vector instruction corresponding to the execution queue entry. In other words, the functional unit 20 would be free to accept the vector instruction in the vector execution queue 19 after the number of clock cycles specified in the throughput count field 197 expires. The throughput count value is counted down by one for every clock cycle until throughput count value reaches zero. When the throughput count value reaches 0, the execution queue 19 dispatches the vector instruction in the corresponding execution queue entry to the functional unit 20. The micro-op field 198 records a micro-op count value representing the number of micro-operations that is specified by the vector instruction of the execution queue entry. The micro-op count value decrements by one for every dispatching of one micro-op until the micro-op count value reaches 0. The corresponding execution queue entry can only be invalidated and start processing the subsequent execution queue entry when the micro-op count value and the throughput count value of the current execution queue entry are 0.

The execution queue 19 may include or couple to an accumulate counter 199 for storing an accumulate count value acc_cnt that is counted down by one for every clock cycle until the counter value becomes zero. The accumulative count of zero indicates that the execution queue 19 is empty. The accumulate count value acc_cnt of accumulate counter 199 indicates a time (i.e., the number of clock cycles) in the future at which the next instruction in decode/issue unit 13 can be dispatched to the functional units 20 or the load/store unit 17 via the execution queue 19. In some embodiments, the read time of the instruction is the accumulate count value, and the accumulate count value is set according to the sum of current acc_cnt and the instruction throughput time (acc_cnt=acc_cnt+inst_xput_time) for the next instruction. In some other embodiments, the read time may be modified, and the accumulate count value acc_cnt is set according to a sum of a read time (rd_cnt) of the instruction and a throughput time of the instruction (acc_cnt=rd_cnt+inst_xput_time) for the next instruction. In some embodiments, the read shifters 161 and the write shifters 163 are designed to be synchronized with the execution queue 19. For example, the execution queue 19 may dispatch the instruction to the functional unit 20 or load/store unit 17 at the same time as the source registers are read from the register file 14 according to the read shifters 161, and the result data from the functional unit 20 or the load/store unit 17 are written back to the register file 14 according to the write shifters 163.

For example, two execution queue entries 190(0), 190(1) are valid and respectively records a first instruction and a second instruction issued after the first instruction. The first instruction in the execution queue entry 190(0) has a throughput time of 5 clock cycles as recorded in the throughput count value 197 and micro-op count of 4 as recorded in the mop_cnt field 198. In the example, one micro-op of the first instruction would be sent to the functional unit 20 for every 5 clock cycles until the micro-op count reaches 0. The total execution throughput time of the first instruction in the first execution queue entry 190(0) would be 20 clock cycles (i.e., 5 clock cycles X 4 micro-operations). Similarly, the total execution throughput time for the second instruction in the second execution queue entry 190(1) would be 16 clock cycles, since there are 8 micro-ops and each has execution throughput time of 2 clock cycles. The accumulate throughput counter 199 would be set to 36 clock cycles, which would be used for issuing a third instruction to the next available execution queue entry (i.e., a third execution queue entry 190(2)).

With reference to FIG. 1, the load/store unit 17 is coupled to the decode/issue unit 13 to handle load instruction and store instruction. In the embodiments, the decode/issue unit 13 issues the load/store instruction as two micro operations (micro-ops) including a tag micro-op and a data micro-op. The execution queues 19D, 19E are referred to tag execution queue (TEQ) 19D and data execution queue (DEQ) 19E, respectively, where the tag micro-op is sent to the TEQ 19D and the data micro-op is sent to DEQ 19E. In some embodiments, the throughput time for micro-ops of the load/store instruction is 1 cycle. The TEQ 19D and DEQ 19E are independent operations, and the TEQ 19D issues the tag micro-op for a tag operation before the DEQ 19E issues the data micro-op for a data operation.

The data cache 18 is coupled to the register file 14, the memory 30 and the load/store unit 17 and configured to temporary store data that are fetched from the memory 30. The load/store unit 17 accesses the data cache 18 for load data or store data. The data cache 18 includes many cache lines of contiguous instruction bytes from memory 30. The cache lines of data cache 18 are organized as direct mapping, fully associative mapping or set-associative mapping similar to the instruction cache 11 but not necessary the same mapping as with the instruction cache 11. The data cache 18 may include a tag array (TA) 22 and a data array (DA) 24 for respectively storing a portion of the address and the data frequently-used by the microprocessor 10. Each tag in the tag array 22 is corresponding to a cache line in the data array 24. When the microprocessor 10 needs to execute the load/store instruction, the microprocessor 10 first checks for an existence of the load/store data in the data cache 18 by comparing the load/store address to tags stored in the tag array 22. The TEQ 19A dispatches the tag operation to an address generation unit (AGU) 171 of the load/store unit 17 to calculate a load/store address. The load/store address is used to access a tag array (TA) 22 of the data cache 18. If the load/store address matches with one of the tag in the tag array (cache hit), then the corresponding cache line in the data array 24 is accessed for load/store data. If the load/store address does not match with any entry in the tag array 22 (cache miss), the microprocessor 10 may access the memory 30 to find the data. In case of cache hit, the execution latency of the load/store instruction is known. In case of cache miss, the execution latency of the load/store instruction is unknown. In some embodiment, the load/store instruction may be issued based on known execution latency of assumed cache hit, which may be a predetermined count value (e.g, 2, 3, 6, or any number of clock cycles). When cache miss is encountered, the issuing of load/store instruction may configure the scoreboard 15 to indicate a corresponding register has a data dependency with unknown execution latency time.

In the following, a process of issuing an instruction with known access time by using the scoreboard 15, accumulated throughput time of the instructions in the execution queue 19 and the read/write control unit 16 would be explained.

When the decode/issue unit 13 receives an instruction from the instruction cache 11, the decode/issue unit 13 access the scoreboard 15 to check for any data dependencies before issuing the instruction. Specifically, the unknown field and count field of the scoreboard entry corresponding to the register would be check for determining whether the previously issued instruction has a known access time. In some embodiments, the current accumulated count value of the accumulate counter 199 may also be access for checking the availability of the functional unit 20. If a previously issued instruction (i.e., a first instruction) and the received instruction (i.e., a second instruction) which is to be issued are to access the same register, the second instruction may have a data dependency. The second instruction is received and to be issued after the first instruction. Generally, data dependency can be classified into a write-after-write (WAW) dependency, a read-after-write (RAW) dependency and a write-after-read (WAR) dependency. The WAW dependency refers to a situation where the second instruction must wait for the first instruction to write back the result data to a register before the second instruction can write to the same register. The RAW dependency refers to a situation where the second instruction must wait for the first instruction to write back to a register before the second instruction can read data from the same register. The WAR dependency refers to a situation where the second instruction must wait for the first instruction to read data from a register before the second instruction can write to the same register. With scoreboard 15 and execution queue 19 described above, instructions with known access time may be issued and scheduled to a future time to avoid these data dependencies.

In an embodiment of handling RAW data dependency, if the count value of the count field 153 is equal or less than the read time of the instruction to be issued (i.e., inst read time), then there is no RAW dependency, and the decode/issue unit may issue the instruction. If the count value of the count field 153 is greater than a sum of the instruction read time and 1 (e.g., inst read time+1), there is RAW data dependency, and the decode/issue unit 13 may stall the issue of the instruction. If the count value of the count field 153 is equal to sum of the instruction read time and 1 (e.g., inst read time+1), the result data may be forwarded from the functional unit recorded in the functional unit field 155. In such case, the instruction with RAW data dependency can still be issued. The functional unit field 155 may be used for forwarding of result data from the recorded functional unit to a functional unit of the instruction to be issued. In an embodiment of handling a WAW data dependency, if the count value of the count field 153 is greater than or equal to the write time of the instruction to be issued, then there is WAW data dependency and the decode/issue unit 13 may stall the issuing of the instruction. In an embodiment of handling a WAR data dependency, if the count value of count field 153 (which records the read time of previously issued instruction) is greater than the write time of the instruction, then there is WAR data dependency, and the decode/issue unit 13 may stall the issue of the instruction. If the count value of the count field 153 is less than or equal to the write time of the instruction, then there is no WAR data dependency, and the decode/issue unit 13 may issue the instruction.

Based on the count value in the count field of the scoreboard 15, the decode/issue unit 13 may anticipate the availability of the registers and schedule the execution of instructions to the execution queue 19, where the execution queue 19 may dispatch the queued instruction(s) to the functional unit 20 in an order of which the queued instruction(s) is received from the decode/issue unit 13. The execution queue 19 may accumulate the throughput time of queued instructions in the execution queue 19 to anticipate the next free clock cycle at which the execution queue 19 is available for executing the next instruction. The decode/issue unit 13 may also synchronize the read ports and write ports of the register file by accessing the read/write control unit 16 to check the availability of the read ports and writes ports of the register file 14 before issuing the instruction. For example, the accumulated throughput time of the first instruction(s) in the execution queue 19 indicates that the functional unit 20 would be occupied by the first instruction(s) for 11 clock cycles. If the write time of the second instruction is 12 clock cycles, then the result data will be written back from the functional unit 20 to the register file 14 at time 23 (or the 23^{rd} clock cycle from now) in the future. In other words, the decode/issue unit 13 would ensure the availability of the register and the read port at 11^{th} clock cycle and availability of the write port for writeback operation at 23^{rd} clock cycle at the issue time of the second instruction. If the read port or write port is busy in the corresponding clock cycles, the decode/issue unit 13 may stall for one clock cycle and check the availabilities of the register and read/write ports again.

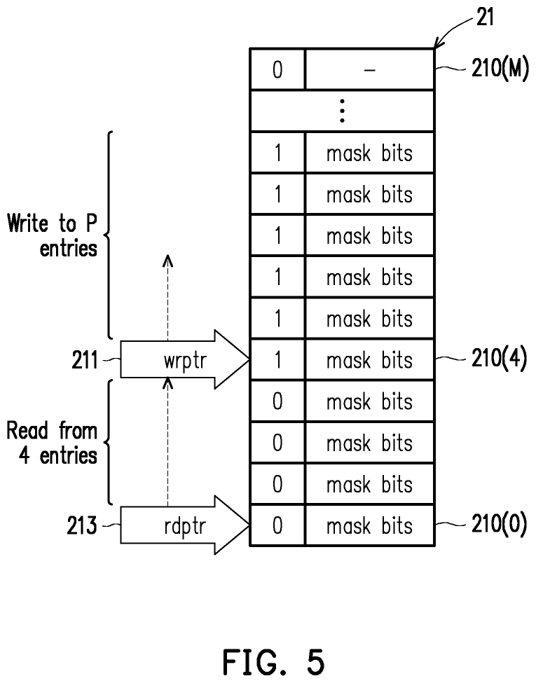

The mask queue 21 handles the mask data of the vector instruction issued to the execution queue 19. FIG. 5 is a diagram illustrating the mask queue 21 in accordance with some embodiments of the disclosure. The mask queue 21 is logically structured to include a plurality of mask entries 210(0)-210(M), where M is an integer greater than 1. Each mask entry includes a plurality of mask data (e.g., 16 bits), where each bit of mask data is corresponding to an element of the vector data. The mask bit indicates if the result data of an element should be written back to the register file 14, i.e. if the mask bit is 1, then the result data of the element is written back to the register file 14. If the mask bit is 0, then result data should not be written back to the register file 14. In the embodiments, the minimum number of elements in a vector register is 16 where the element is 32-bit data, thus the mask entry is set to have 16 mask bits in the embodiments. The result data for each element are enabled by individual mask bit to write back to the register file. For example, the mask bits (data) of 1111_1111_0000_1111 indicates that elements 5-8 (i.e., bit 4 thru bit 7 of mask data) are blocked from writing back to the register file 14. In the embodiments, the maximum number of data elements in a vector register is 64 where the element is 8-bit wide data, thus 4 mask entries are needed to enable the writing back of 64 elements to the register file 14. In the embodiments, the maximum vector length multiplier (LMUL) is 8 in which case a vector instruction can write back result data to 8 vector registers of the register file 14. Since each vector register can have 64 data elements in the case of 8-bit wide data per data element, the vector instruction can have a maximum of 512 data elements (i.e., 8 vector registers of 64 elements each), which may be referred to as a worst-case vector instruction (or worst-case scenario) hereinafter. The mask queue 21 needs to have a minimum 512 mask bits for the worst case vector instruction, and therefore, the mask queue 21 is logically structured to have 32 mask entries and 16-bit mask per mask entry. That is, every bits of mask register would be needed to perform mask operation for one single vector instruction. It should be noted that 512-bit wide mask register is used here for the purpose of illustrated only. The disclosure may be applied to other mask registers having various size without departing from the disclosure. For example, the mask register size may be 32, 64, 128, 1024, or any other number of bits. Furthermore, mask queue may be logically structured to have different number of mask entries and\or different number of bits per mask entry without departing from the scope of the disclosure. For example, mask queue having 16 mask entries of 32-bits or 64 mask entries of 8-bits may be used to handle 512-bit mask data. In yet other embodiments, a mask queue having 64 entries of 16 bits or 32 entries of 32 bits may be used to handle 1024-bit mask data. In the above description, the size of the mask queue 21 may be dependent from the width of the register file 14. However, the disclosure is not intended to limit the size of the mask queue 21. In an alternative embodiment, the total number of mask bits in the mask queue 21 may be independent of the width of the register file. For example, the mask queue 21 may have 40 entries of 16-bit mask entries for a total of 640 mask bits.

The mask operation may represent in a predicate operand or conditional control operand, or conditional vector operation control operand. In the embodiments, the mask operation may be enabled based on bit 25 of the vector instruction. In other words, the bit 25 of the vector instruction indicates the vector instruction is a masked vector instruction or an unmasked vector instruction. Other bits in the vector instruction may be used for enabling mask operation, the disclosure is not intended to limit thereto. The mask data of the mask queue 21 may be used to predicate, conditionally control, or mask whether or not individual results of the operations are to be stored as the data elements of destination operand and/or whether or not operations associated with the vector instruction are to be performed on the data elements of source operand. Typically, one mask bit would be attached to each data element of vector instruction. The number of mask data varies based on vector data length (VLEN), data element width (ELEN), and vector length multiplier (LMUL). The vector length multiplier represents the number of vector registers that are combined to form a vector register group. The value of the vector length multiplier may be 1,2,4,8, and so on. The number of the data elements may be calculated by dividing vector data length by data element width (VLEN/ELEN), and each data element would require a mask bit when the mask operation is enabled. With vector length multiplier, one single vector instruction may include various number of micro-ops, and each of the micro-ops also requires mask data to perform mask operation. In a case of vector length multiplier being 8, i.e., LMUL=8, the number of data elements for one single instruction increases by 8 times as compare to LMUL=1 (i.e., (VLEN×LMUL)/ELEN). In a case of 512-bit wide vector data and 8 micro-ops, the number of data elements for one single vector instruction may be as large as 512 elements when the data element width is 8-bit (ELEN=8). In such case, 512-bit mask data are required, which may be referred to as a worst-case scenario of the 512-bit mask register. On the other hand, a vector instruction having data element width of 32-bit and 1 micro-op (LMUL=1) would only require 16-bit mask data, which may be referred to as a best-case scenario for mask register). In the brute-force implementation, each entry of execution queue would be equipped with 512 bits for handling the possibility of 512-bit mask data regardless of whether the vector instruction in the execution queue requires all of the 512 bits or not. If the execution queue has 8 entries, a total of 32,768 bits (8×8×512) would be required to handle masks in the worst-case scenario for every entry in the execution queue. This is an excessive storage for mask. In the embodiments, the mask queue is dedicated to handle the mask of vector data for all of the queue entries of the execution queue instead reserving 512 bits in every queue entry for handling mask.

In the embodiments of 512-bit wide mask register v(0), 32 mask entries of the mask queue 21 would have the capability to handle mask data for 32 vector instructions having 32-bit wide data element when LMUL being 1, where only the first 16 bits of mask register are mask data for the vector registers (i.e., the best-case scenario). When LMUL is 8, the mask queue 21 has the capability to handle 4 vector instructions having 32-bit wide data element, where first 128 bits of the mask register are mask data for the vector registers. For 16-bit wide data element, the mask queue 21 has the capability to handle mask data for 16 vector instructions when LMUL being 1 (i.e., 32 mask data) and 2 vector instructions when LMUL being 8 (i.e., 256 mask data). For 8-bit wide data element, the mask queue 21 has the capability to handle mask data for 8 vector instructions when LMUL being 1 (i.e., 64 mask data) and 1 vector instruction when LMUL=8 (i.e., 512 bits of mask data).

It should be noted that 512-bit wide mask register is utilized to show the concept of the invention, mask register having different width such as 32, 63, 128, 1024 bits may also be adapted to handle the mask data of the mask operation. For example, in an embodiment of 1024-bit wide mask register, the microprocessor may be equipped with a 1024-bit wide mask queue to handle the worst-case scenario (e.g., VLEN=1024, ELEN=8, MLUL=8). Furthermore, the width of data element and the number of vector length multiplier (LMUL) may also varies without departing from the scope of the invention. The same algorithm of mask queue as described in the specification may also be adapted to handle data element having a wide of 64 bits, 128 bits, etc.

In the embodiments, the mask queue 21 may be accessed by rotating pointers such as a write pointer (“wrptr”) 211 and a read pointer (“rdptr”) 213. The write pointer 211 is incremented per allocation of one vector instruction in the execution queue. The read pointer 213 is incremented per completion of one vector instruction. The mask data are written to the mask queue 21 as one entry of R bits (e.g., R=512 bits) and read from the mask queue 21 as M entries (e.g., M=32 entries).

In a write operation of the mask queue 21, the entire width of mask register v(0) may be written to the mask queue 21 as one entry when a vector instruction is issued to the execution queue 19. That is, 512 bits (i.e., the total width of mask register v(0)) may be written to the mask queue 21 starting from a mask entry specified by a position of the write pointer 211. To be specific, the 32 entries of the mask queues are enabled for writing of the 512-bit mask data starting from the write pointer 211. The relocation of the write pointer 211 may be calculated based on the number of mask data required by the vector data of the issued vector instruction. For example, a first vector instruction has 2 micro-ops (i.e., LMUL=2), and the vector data has a data element width (ELEN) of 16 bits. The vector data would have 64 data elements, which requires the first 64 bits of the mask register v(0) for mask operation. The relocation of the write pointer 211 would be calculated based on 64-bit (4×16) mask data required by the first vector instruction. To be specific, the 4 entries of the mask queues 21 are enabled for writing of the 64-bit mask data starting from the write pointer 211. The mask queue 21 is written as a single entry of 512-bit mask data but only 4 mask entries are enabled for writing of the 64-bit mask data while the 448-bit mask data are blocked from writing into the mask queue 21. Each mask entry may be assigned with a write enable bit (not shown) for indicating whether a corresponding mask entry is enabled for write operation or not. In the example, the write pointer 211 would be incremented by 4 entries. If the first vector instruction is issued to the first queue entry 190(0) of the execution queue 19, the write operation would start from the first mask entry 210(0) and the write pointer 211 would be incremented from the first mask entry 210(0) to the fifth mask entry 210(4). When a second vector instruction is issued to the second queue entry 190(1), the entire width of the mask register v(0) would be used to write to the mask queue 21 as one entry. The write operation of mask queue 21 for the mask data of the second vector instruction would start from the new position of the write pointer, i.e., 5^{th} mask entry 210(4). If the second vector instruction is the worst-case scenario that requires the entire width (e.g., 512 bits when VLEN=512, ELEN=8 bits and LMUL=8) of the mask queue 21, the issuing of the second vector instruction would be stalled in the decode/issue unit until the first vector instruction is dispatched to the functional unit 20. In another scenario, if the first vector instruction is the worst-case scenario that requires the entire width of the mask queue 21 for mask operation, the issuing of the second vector instruction subsequent to the first vector instruction would be stalled until the first vector instruction is dispatched to the functional unit 20. However, in the alternative embodiments of mask queue 21 not being dependent from the width of the mask register, the size of the mask queue 21 may handle more mask bits in addition to the 512-bit mask data in the worst-case scenario of 512-bit wide vector register. In such embodiments, the second instruction may still be issued after the first vector instruction that has the worst-case scenario as long as the number of available mask entries in the mask queue 21 is sufficient to handle the mask data corresponding to the second vector instruction. In any cases, the vector instruction may be stall in the decode/issue unit 13 until the number of available mask entries in the mask queue 21 are enough to hold the new mask data for the vector instruction.

The read operation of mask queue 21 starts from the mask entry that is pointed to by the read pointer 213 and increments when the corresponding vector instruction in the execution queue 19 is dispatched to the functional unit 20. The vector instruction may have many micro-ops as indicated by micro-op count field 198 where the micro-op count field 198 is decremented by 1 every time a micro-op is dispatched to the functional unit 20. All micro-ops of the vector instruction are issued to the functional unit 20 when a count value of 0 is in the micro-op count field 198 in which case the valid bit field 191 of the entry of execution queue 19 is reset and the read pointer of the mask queue 21 can be incremented. The read pointer 213 points to one of the mask entries corresponding to the first micro-op of the vector instruction (referred to as a current read mask entry). The read operation may read X consecutive mask entries starting from the current read mask entry, where X may be an integer greater than 0. The current read mask entry may be offset by the order of micro-ops to read the corresponding mask data stored in the mask queue 21. For 8-bit elements, the number of mask bits required for a vector operation is 64-bit mask data or 4 mask entries of the mask queue 21. For 16-bit elements, the number of mask bits required for a vector operation is 32-bit mask data or 2 mask entries of the mask queue 21. For 32-bit elements, the number of mask bits required for a vector operation is 16-bit mask data or 1 mask entry of the mask queue 21. The number of mask entries for each micro-op is referred to herein as the micro-op mask size, i.e. 4 mask entries for 8-bit element, 2 mask entries for 16-bit element, and 1 mask entry for 32-bit element. In the embodiments, instead of calculating the exact number of mask entries to read for different element length (8-bit, 16-bit, and 32-bit elements), four mask entries (i.e., X=4) are read each time. In the case of 8-bit wide data element, all 4 entries are used for each micro-op. In the case of 16-bit wide data element, the first 2 entries are used for each micro-op. In the case of 32-bit wide data element, the first entry is used for each micro-op. Therefore, the read operation of the mask queue 21 is configured to read at least 64 bits, i.e., four 16-bit wide mark entries, to handle each micro-op that may have various widths of the mask data due to the data element width.

As described above, the current read mask entry may be offset by the order of the micro-ops. If a vector instruction has three micro-ops, the first micro-op would read 4 consecutive mask entries starting from the mask entry pointed by the read pointer 213. The second micro-op would read 4 consecutive mask entries starting from a modified read pointer. In the embodiments, the read pointer is modified by adding the micro-op mask size (which depends on the width of the data elements) to the read pointer 213. The third micro-op would read 4 consecutive mask entries starting from the modified read pointer by adding 2 micro-op mask sizes to the read-pointer 213. In the case of 32-bit wide data element, which has a micro-op mask size of one mask entry (i.e., 16 mask bits), the read pointer 213 points to the mask entry 210(0) as the current read mask entry. The first micro-op reads the four consecutive mask entries 210(0)-210(3) starting from the mask entry 210(0). The second micro-op reads the mask entries 210(1)-210(4) starting from the mask entry 210(1), where the mask entry pointed by the read pointer 213 is modified by adding 1 micro-op mask size to the position of the read pointer 213. The third micro-op reads the mask entries 210(2)-210(5) starting from the mask entry 210(2), where the mask entry pointed by the read pointer 213 is modified by adding 2 micro-op mask size to the position of the read pointer 213, and so on. The number of the micro-op mask size to be applied depends from the order of the micro-ops or the vector instruction. In the embodiments, 64-bit mask data may be read from mask queue 21. However, the mask data required by the micro-op of the vector instruction may varies based on the width of data element. In the case of 16-bit wide data element, only 32-bit mask data is needed for a micro-op of 512-bit wide vector data length, and the read operation of mask data would increment by a factor of a micro-op mask size of 2 mask entries. The micro-op would use the first 32 bits of the 64-bit read mask data (i.e., read mask data [31:0]) and ignore the last 32 bits of the 64-bit read mask data (i.e., read mask data [63:32]). It should be noted that the read operation of four consecutive mask entries is not intended to limit the disclosure. The read operation of the mask queue 21 may involve various number of mask entries such as 1, 2, 4, 8, 16, and so on may be implemented without departing from the scope of the disclosure. In an alternative embodiment of 1024-bit wide vector data, the execution queue 19 may be configured to read eight consecutive mark entries (i.e., 128-bit mask data).

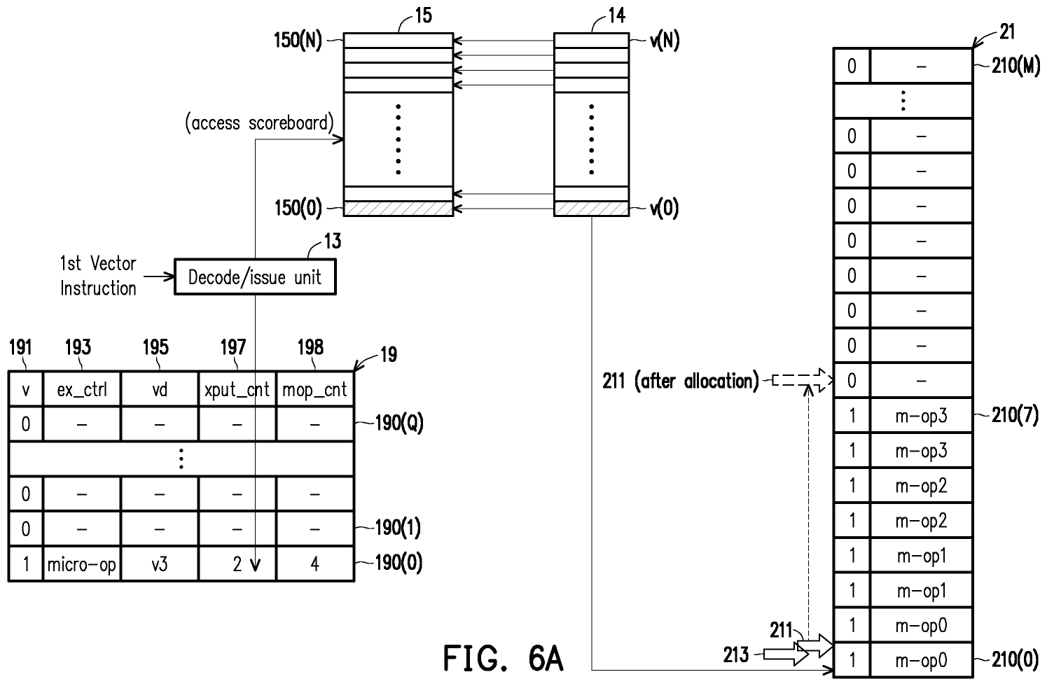

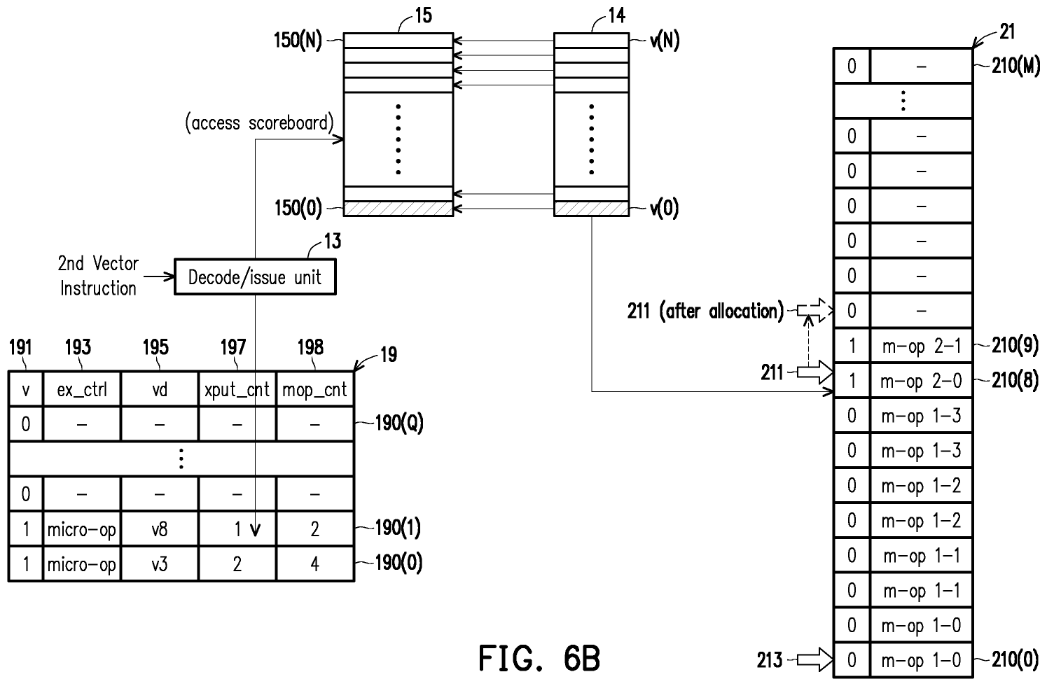

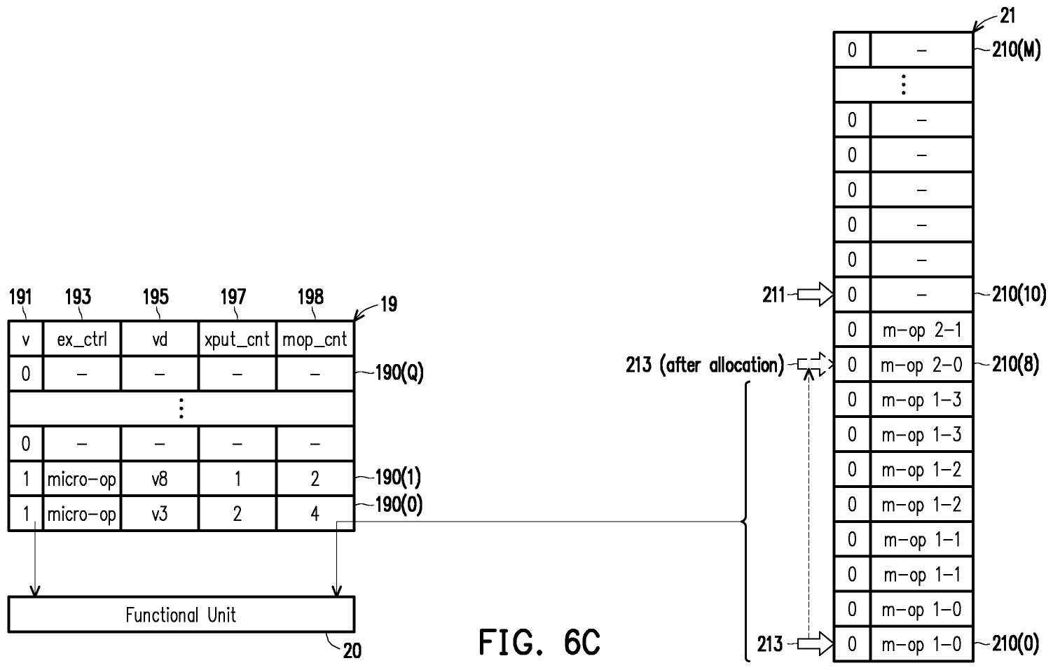

FIGS. 6A-6C are diagrams illustrating an operation of issuing a vector instruction to an execution queue 19 and a mask queue 21 in accordance with some embodiments of the disclosure. With reference to FIG. 6A, a first vector instruction including 4 micro-ops is received to operate on 512-bit wide vector data with 16-bit wide data elements. The decode/issue unit 13 checks whether the mask operation is enabled or not and accesses the scoreboard to check the availability of the corresponding registers and mask registers v0. In the embodiments, the mask register v(0) may be hardwired to the decode/issue unit 13 with a dedicated read port. If there is a pending write operation to the mask register v(0), the scoreboard entry 150(0) include a busy information to indicate that the mask register v0 is not ready for access. The busy information in scoreboard entry 150(0) may be implemented by setting the unknown field 1511 (or 1521), the count field 1513 (or 1523) or an additional field in the scoreboard entry 150(0) that indicates the mask register v(0) is busy.

As an example, the first vector instruction is issued and allocated to the first queue entry 190(0) of the execution queue 19, while the mask data corresponding to the first vector instruction would be allocated to a first plurality of mask entries 210(0)-210(7) of the mask queue 21 based on the write pointer 211. Instead of allocating 512-bit wide mask data from the mask register v(0) in first queue entry 190(0) as part of the first vector instruction in queue, the mask data is allocated to the mask queue 21 based on the position of write pointer 211. The mask data may be sent from the mask register v(0) to the mask queue 21 directly, through hard-wire bus or through the decode/issue unit 13 as part of issuing of the first vector instruction, the disclosure is not intended to limit the transmission path of the mask data. In the embodiments, the first vector instruction would have 128-bit wide mask data (4×32) due to the 16-bit wide data element and 4 micro-ops, which requires 8 mask entries. After the allocation of the first vector instruction, the write pointer 211 is incremented by 8 to indicate the next mask entry for the next vector instruction. In the embodiments, the write enable bits for the first 8 mask entries are set starting from the write pointer 211 to allow 128-bit mask data to be written to the mask queue 21.

With reference to FIG. 6B, a second vector instruction including 2 micro-ops is received after the first vector instruction is allocated to the execution queue 19. The second vector instruction is configured to operate on 512-bit wide vector data with 32-bit wide data elements. Based on the structure of the second vector instruction (i.e., ELEN=32, LMUL=2), 32 mask data would be needed to perform mask operation on the second vector instruction, which requires 2 mask entries to store. The 32-bit wide mask data corresponding to the second vector instruction is written to the mask queue 21 starting from the current write mask entry indicated by the current position of the write pointer 211, which would be the mask entry 210(8). As illustrated in FIG. 6B, mask data (“m-op 2-1”) corresponding to the first micro-op of the second vector instruction is written to the mask queue 210(8), and the mask data (“m-op 2-2”) corresponding to the second micro-op of the second vector instruction is written to the mask queue 210(9). After the allocation of the second vector instruction, the write pointer 211 is incremented by 2 to indicate the next mask entry for the next vector instruction. In the embodiments, the write pointer 211 would be repositioned to mask queue 210(10) to indicate the next available mask entry for storing mask data of vector instruction after the second vector instruction.

With reference to FIG. 6C, an operation of dispatching the first vector instruction in the first queue entry 190(0) is illustrated. As described above, each micro-op of the first vector instruction operates on vector data having thirty-two 16-bit wide data elements. Therefore, 32 bits of mask data would be dispatched with each micro-op of the first vector instruction. The micro-op mask size is 2 for each micro-op where the read pointer 213 is modified to 0, 2, 4, 6 to read mask data for each micro-op instruction, and the read operation of each micro-op would read 4 consecutive mask entries starting from the modified read pointer 213. In the embodiments, the execution queue 19 access the mask queue 21 to obtain the mask data of the first vector instruction in the queue entry 190(0). The first micro-op of the first vector instruction would be dispatched to the functional unit 20 with mask data stored in the four mask entries 210(0)-210(3) of the mask queue 21. Since the vector data is 16-bit wide data element, the functional unit 20 can only use the first 32-bit mask data (e.g., bit[31:0]) and ignore the second 32-bit mask data (e.g., bit[63:32]). For the second micro-op, the current read mask entry would be offset by one micro-op mask size. In other words, the second micro-op of the first vector instruction would read 4 consecutive mask entries 210(2)-210(5) to dispatch to the functional unit 20. The functional unit 20 can only use the first 32-bit masked data stored in the two mask entries 210(2)-210(3) of the mask queue 21 and ignore the other 32-bit from mask entries 210(4)-210(5). The third micro-op of the first vector instruction would be dispatched to the functional unit 20 with mask data stored in the four mask entries 210(4)-210(7) of the mask queue 21, where the read pointer 213 is modified by two micro-op mask sizes. The fourth micro-op of the first vector instruction would be dispatched to the functional unit 20 with mask data stored in the four mask entries 210(6)-210(9) of the mask queue 21, where the read pointer 213 is modified by 3 micro-op mask sizes. When the first vector instruction is completely dispatched to the functional unit 20, the read pointer 213 is incremented by four micro-op mask sizes which would be 8 mask entries in the case of 16-bit wide data element.

In the case of dispatching the second vector instruction to the functional unit 20, the micro-op mask size is 1 due to the 32-bit wide data element. The first micro-op of the second vector instruction would be dispatched to the functional unit 20 with mask data stored in the mask entry 210(8)-210(11). Since the vector data is 32-bit wide data element, the functional unit 20 can only use the first 16-bit mask data and ignore the other 48-bit mask data. The second micro-op of the second vector instruction would be dispatched to the functional unit 20 with mask data stored in the mask entry 210(9)-210(12).

In some embodiments, double-width vector instruction may be issued to the execution queue 19. In the operation of the double-width vector instruction, a result data of the vector operation would be two times of the width of the source data. In detail, the first half of the source data (i.e., half register width) is used to produce a first result data having full register width, and the second half of the source data are used to produce a second result data having full register width. The source registers are read twice when each micro-op of the double-width vector instruction is executed. In the embodiments, the mask data is for the result data width and not the source data width. As an example, the element data width is 16-bit and the result data width is 32-bit for the double-width instruction. For example, with LMUL=4, the “single-width” vector instruction of 16-bit elements would have 4 micro-op instructions and write back to 4 vector registers of the register file 14 and each micro-op instruction has 32-bit mask data. The “double-width” vector instruction of 16-bit elements would have 8 micro-op instructions and write back to 8 vector registers of the register file 14, where each micro-op instruction has 16-bit mask data. Referring back to FIG. 6C, the first vector instruction is a “single-width” vector instruction, which has 4 micro-ops each with mask data consist of 2 mask entries (i.e., m-op 1-0 is 210(0)-210(1)). In a case of “double-width” vector instruction, instead of 4 micro-ops each with 2 mask entries, a double-width vector instruction would be logically view as 8 double-width micro-ops use one single mask entry for each double-width micro-op. For example, mask data in the 8 mask entries 210(0)-210(7) corresponding to the double-width first vector instruction in the first queue entry 190(0) may be logically viewed as “m-op 1-0”, “m-op 1-1”, “m-op 1-2”, “m-op 1-3”, “m-op 1-4”, “m-op 1-4”, “m-op 1-5”, “m-op 1-6”, and “m-op 1-7”. In some other embodiments, the reading operation mask data from the mask queue 21 may be delayed by 1 clock cycle, since the source operand data elements must be shifted into correct positions for operation.

In some other embodiments, if a second vector instruction uses the same mask vector register v(0), same LMUL, and same ELEN, then the second vector instruction can use the same set of mask entries in the mask queue 21 as a first vector instruction. The embodiments do not intend to exclude other sizes of LMUL and ELEN, as long as the mask bits can be derived from the same mask entries based on v(0). There is no need to write the same mask data into the mask queue 21. The same mask vector register v(0) means that the vector register v(0) is not written by another instruction in between the first and the second vector instructions. A scoreboard bit can be used to indicate the status of the mask vector register v(0). The LMUL and ELEN values are stored with the read pointer 213 in order to validate the same LMUL and ELEN of the next vector instruction. The read pointer 213 is used as the identifier for the set of mask entries for a vector instruction. The mask queue 21 may include a vector instruction counter (not shown) to keep track of number of vector instructions using the same set of mask entries, so that the read pointer 213 would only be relocated when the vector instruction counter reaches 0. As each vector instruction uses the same set of mask entries, when the vector instruction is dispatched to the execution queue the vector instruction counter is incremented by 1. When all micro-ops of a vector instruction are dispatched from the execution queue 19 to the functional unit 20, then the vector instruction counter in the mask queue entry is decremented. When vector instruction counter is zero, then the read pointer 213 is incremented by the number of micro-ops, each micro-op has the micro-op mask size. The above description of reusing the mask entries in the mask queue 21 is more efficient usage of mask data and power since the same mask data are not written multiple times into the mask queue 21.

In the above, the mask data is shared by multiple vector instructions in the same execution queue. However, the sharing of mask data is not limited to vector instructions in the same queue. In some other embodiments, the mask data of one mask queue may be shared by multiple vector instructions in different execution queues. For example, a first vector instruction may be issued to the execution queue 19B with a first mask data to the mask queue 21B. If a second vector instruction is issued to the execution queue 19C and have uses the same mask data (i.e., the same mask vector register v(0), same LMUL, and same ELEN) as the first vector instruction in the execution queue 19B, the second vector instruction may also share the mask data in the mask queue 21B. The vector instruction counter as described above may also be used to countdown the first and second vector instructions. In yet some other embodiments, one mask queue may be shared between the execution queues even if the first and second vector instruction do not use the same mask data.

In accordance with the above embodiments, the mask data may be handled by the mask queue presented above, instead of reserving 512 bits (or any width of the mask register) in every entry of execution queue. In the disclosure, mask data of multiple vector instructions may be stored in the mask queue. The corresponding mask data may be accessed from the mask queue when the vector instruction(s) is dispatched from the execution queue to the functional unit for execution. The issuing of the vector instruction from the decode/issue unit to the execution queue may be stalled until the mask queue does not have enough entries to write the mask data.

In the embodiments, one mask queue may be dedicated to one execution queue. In some other embodiments, the mask queue 21 may be shared by more than one execution queues. The same vector mask with same LMUL and ELEN can be used for multiple vector instructions in different functional units in which case of sharing of the mask queue between multiple execution queues may save more area. The embodiments do not limit the sharing of mask queue by multiple execution queues because of sharing of the mask queue entries by vector instructions in different execution queues. Rather, the mask queue can be shared even if vector instructions in different execution queues do not share any mask queue entries. The mask queue entries are marked with LMUL and ELEN, if the second vector instruction uses the same mask vector register, LMUL, and ELEN, then the set of mask queue entries (e.g., 210(0)-210(7) of FIG. 6C) are used for the second vector instruction, else a new set of mask queue entries are created if the mask queue has enough entries. The set of mask queue entries includes a counter to keep track of the number of vector instructions in the execution queues which use this set of mask queue. The execution queue must keep track of the read pointers 213 to the mask queue 21 to access for mask data for each issued micro-op to functional unit 20. When all micro-ops of a vector instruction are dispatched from execution queue 19 to the functional unit 20, then the vector instruction count in the mask queue is decremented by 1. When the vector instruction count in the mask queue 21 is zero, then the set of mask entries are available to accept new set of mask data from vector instruction issuing from the decode/issue unit 13. In all cases, resources are conserved without dedicating additional storage space for handling mask data of the vector instruction.

In accordance with one of the embodiments, a microprocessor includes a decode/issue unit and an execution queue. The execution queue includes a plurality of queue entries and a mask queue. In the embodiments, the execution queue is configured to allocate a first instruction issued from the decode/issue unit and operating on data having a plurality of first data elements to a first queue entry. The mask queue includes a plurality of mask entries, and a first mask data corresponding to the first instruction is written to a first number of mask entries when the first instruction is allocated to a first queue entry in the execution queue, wherein the first number are determined based on a width of the first data element.

In accordance with one of the embodiments, a method of handling mask data of vector instructions includes at least the following steps: a step of issuing a first instruction operating on data having a plurality of first data elements to an execution queue which includes a mask queue, a step of allocating the first instruction to a first queue entry in the execution queue, and a step of writing a first mask data corresponding to the first instruction to a first number of mask entries in the mask queue, wherein the first number is determined based on a width of the first data element.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A microprocessor, comprising:
a decode/issue unit; and
an execution queue, including a plurality of queue entries and a mask queue, and allocating a first instruction issued from the decode/issue unit and operating on data having a plurality of first data elements to a first queue entry,
wherein the mask queue includes a plurality of mask entries, and a first mask data corresponding to the first instruction is written to a first number of mask entries when the first instruction is allocated to a first queue entry in the execution queue, wherein the first number are determined based on a width of the first data element.

2. The microprocessor of claim 1, wherein the execution queue further allocates a second instruction issued from the decode/issue unit and operating on data having a plurality of second data elements to a second queue entry subsequent to the first queue entry, and the mask queue writes a second mask data corresponding to the second instruction to a second number of mask entries, wherein the second number is determined based on a width of the second data element.

3. The microprocessor of claim 2, wherein the decode/issue unit is configured to stall the second instruction if the mask queue does not have enough space for storage of the mask data of the second instruction.

4. The microprocessor of claim 1, wherein the determination of the first number of the mask entries for storing the first mask data is further based on a vector length multiplier (LMUL) of the first instruction.

5. The microprocessor of claim 1, wherein the first number of the mask entries starts from a first write mask entry indicated by a write pointer, and the write pointer is repositioned by the first number of the mask entries upon the allocation of the first instruction to the first queue entry of the execution queue, and a second mask data corresponding to a second instruction is written to a second write mask entry indicated the write pointer after the reposition of the write pointer.

6. The microprocessor of claim 1, wherein the execution queue is further configured to dispatch the first instruction to a functional unit with first mask data by accessing the first number of the mask entries according to a current read mask entry indicated by a read pointer, and the execution queue reads X number of mask entries per micro-op starting from the current read mask entry, wherein the x is an integer equal to or greater than 1,
wherein the read pointer is repositioned upon a completion of dispatching the first instruction to the functional unit based on the width of the data element and a vector length multiplier (LMUL) corresponding to the first instruction.

7. The microprocessor of claim 6, wherein, for each micro-op of the first instruction, the current read mask entry is offset by a factor of micro-op mask size based on an order of micro-ops of the first instruction, and the micro-op mask size is determined based on a width of the data element corresponding to the first instruction.

8. The microprocessor of claim 7, wherein the first instruction is a double width instruction, and the micro-op mask size is modified based on the number of modified double-width micro-ops and the timing of reading the mask data is delayed in offsetting the current read mask.

9. The microprocessor of claim 1, wherein the execution queue further allocates a second instruction issued from the decode/issue unit and operating on data having a plurality of second data elements to a second queue entry subsequent to the first queue entry, and wherein the second instruction is determined to use the same mask entries as the first instruction in the first queue entry, and the first and second instructions are dispatched to the same functional unit.

10. The microprocessor of claim 9, the mask queue further includes a vector instruction counter configured to count the first and second instructions and to decrement by one when the first instruction or the second instruction is issued to the corresponding functional units, and a read pointer of the mask queue is relocated when the instruction counter reaches 0.

11. The microprocessor of claim 1, wherein the execution queue includes a first execution queue corresponding to a first functional unit and a second execution queue corresponding to a second functional unit, the decode/issue unit is further configured to issue a second instruction operating on data having a plurality of second data elements to a first queue entry of the second execution queue, a second mask data corresponding to the second instruction is written to a second number of mask entries of the mask queue which is shared with the first instruction in the first entry of the execution queue, wherein the first and second instructions are dispatched by the first and second execution queues to the first and second functional units, respectively.

12. The microprocessor of claim 11, wherein the first number of the mask entries corresponding to the first instruction and the second number of the mask entries corresponding to the second instruction are the same mask entries in the mask queue.

13. A method, comprising:
issuing a first instruction operating on data having a plurality of first data elements to an execution queue which includes a mask queue;
allocating the first instruction to a first queue entry in the execution queue; and
writing a first mask data corresponding to the first instruction to a first number of mask entries in the mask queue, wherein the first number is determined based on a width of the first data element.

14. The method of claim 13, the method further comprising:
allocating a second instruction operating on data having a plurality of second data elements to a second queue entry subsequent to the first queue entry in the execution queue; and
writing a second mask data corresponding to the second instruction to a second number of mask entries, wherein the second number is determined based on a width of the second data element.

15. The method of claim 14, where in the first number is further determined based on a first vector length multiplier (LMUL) of the first instruction, and the second number is further determined based on a second vector length multiplier of the second instruction.

16. The method of claim 14, the method further comprising:
writing the first mask data based on a write pointer;
repositioning the write pointer based on the width of the data element of the first instruction and a vector length multiple of the first instruction upon the allocation of the first instruction to the first queue entry; and
writing the second mask data corresponding to the second instruction starting from a current write mask entry among the mask entries as indicated by the repositioned write pointer, wherein the current write mask entry is immediately subsequent to the portion of mask entries that stores the first number of the first mask data.

17. The method of claim 13, the method further comprising:
issuing a second instruction to the execution queue;
dispatching the first instruction with the first mask data read from the first number of mask entries to a first functional unit; and
dispatching the second instruction with the first mask data read from the first number of mask entries to a first functional unit.

18. The method of claim 17, the method further comprising:
incrementing an instruction count by one when each of the first and second instructions is issued; and
decrementing the instruction count by one when one of the first and second instructions is dispatched; and
repositioning a read pointer by the first number of the first mask data determined based on the width of the data element of the first instruction and the number vector length multiple when the micro-op count reaches 0.

19. The method of claim 13, wherein the execution queue includes a first execution queue corresponding to a first functional unit and a second execution queue corresponding to a second functional unit, the method further comprising:
issuing the first instruction and a second instruction to the first execution queue and the second execution queue, respectively, and writing the first mask data and a second mask data corresponding to the second instruction to the same mask queue which is shared between the first and second execution queue; and
dispatching the first and second instructions from the first and second execution queues to a first functional unit and a second functional units.

20. The method of claim 13, the method further comprising:
reading X number of consecutive mask entries to obtain the first mask data starting from a current read mask entry indicated a read pointer until a micro-op count reach 0, wherein the X is equal to or greater than 1;
offsetting the read pointer by a factor of micro-op mask size based on an order of micro-ops of the first instruction and the width of the data element, wherein the micro-op size is determined based on a width of the data element corresponding to the first instruction; and
repositioning the read pointer based on the width of the data element of the first instruction and the number vector length multiple when the micro-op count reaches 0.
